(19) United States
(12) Patent Application Publication
(10) Pub. No.: US 2006/0162400 A1
(43) Pub. Date: Jul. 27, 2006

(54) Combination lock having a deceptive structure to protect the lock from being unlocked via inappropriate measure

(76) Inventor: Lambert Kuo, Tainan (TW)

Correspondence Address: Jackson Walker L.L.P., Suite 2100, 112 E. Pecan Street, San Antonio, TX, 78205, US

(21) Appl. No.: 11/041,798

(22) Filed: Jan. 24, 2005

(51) Int. Cl. E05B 37/02

(52) U.S. Cl. 70/30

(57) ABSTRACT

A combination lock has a latching rod, a positioning rod and multiple combination wheel assemblies each provided with a combination ring, a positioning ring and an abutting ring. Multiple detents are defined in a rear side face of the positioning ring to temporarily receive the bosses in the latching rod while the combination is not able to align the bosses with the cutout in the positioning ring such that any attempt of deducing the correct combination by pulling the latching rod and rotating the combination rings is eliminated.

### BACKGROUND OF THE INVENTION

1. Field of the Invention

The present invention relates to a combination lock, and more particularly to a combination lock having a deceptive structure therein such that inappropriate measure trying to unlock the lock is avoided.

2. Description of Related Art

There are many combination locks currently available in the market, and the combinations of which can be changed. However, these locks usually have a complex structure that is not easy nor convenient to manufacture and assemble. Moreover, the combination may be accidentally changed in use such that even the owner does not know the resultant combination, and the combination lock is consequently useless. A conventional combination lock is shown in FIGS. 10 and 11. The combination lock includes a cable (40) with two ends respectively and integrally provided with a positioning rod (41) and a latching rod (42). Between the positioning rod (41) and the latching rod (42), a combination changing device (60) adjacent to the latching rod (42) and multiple combination wheel assemblies (50) are provided. The positioning rod (41) has an annular covering (411) and a positioning extension (412) centrally extending from an inner face of the annular covering (411) and having a flat bottom, a slot (413) defined in a top of the positioning extension (412), first positioning blocks (414) formed on a right side of the positioning extension (412) and second positioning blocks (415) formed on a left side of the positioning extension (412) and the second positioning blocks (415) having a dimension different from that of the first positioning blocks (414). A positioning hole (416) is defined in one of the first positioning blocks (414) close to a free end of the positioning extension (412).

The latching rod (42) has an annular housing (421) and a latch (422) centrally extending from a bottom of the annular housing (421) and having multiple bosses (423) formed on top of the latch (422) to correspond to the slot (413) of the positioning rod (41).

Each combination wheel assembly (50) is composed of a combination ring (51), a positioning ring (52), an abutting ring (53) and a first spring (54). The combination ring (51) is encrypted with numerals (not shown) on sectioned outer surface of the combination ring (51) and has a central hole (511) and multiple positioning recesses (512) defined in an inner face defining the central hole (511) to correspond to the numerals. The positioning ring (52) is configured to have a rim (521) formed on an outer periphery of the positioning ring (52), multiple spatially spaced annular protrusions (522) formed around an inner face of the positioning ring (52) facing the combination ring (51), a centrally defined hole (523) communicating with the central hole (511) of the combination ring (5 1), a cutout (524) defined through the annular protrusion (522) to correspond to the slot (413) of the positioning rod (41), bosses (525) formed on a bottom periphery of the annular protrusion (522) to correspond to the positioning recess (512) of the combination ring (51), a first receiving recess (526) defined in the inner face defining the hole (523) to correspond to the first positioning block (414) and a second receiving recess (527) defined in the inner face defining the hole (523) to correspond to the second positioning block (415) of the positioning rod (41). The abutting ring (53) has an extension hole (531), a second cutout (532) defined in an inner face defining the extension hole (531), a first mating recess (533) defined in the inner face defining the extension hole (531) to correspond to the first positioning block (414) of the positioning rod (41), a second mating recess (534) defined in the inner face defining the extension hole (531) to correspond to the second positioning block (415) of the positioning rod (41), an annular ridge (535) formed on a side face of the abutting ring (53) facing the positioning ring (52) and two fixing holes (536) oppositely defined in an outer periphery of the annular ridge (535) to correspond to and receive therein two ends of the first spring (54).

When the conventional combination lock is assembled, a second spring (417) is mounted around the positioning extension (412). Then the abutting ring (53), the positioning ring (52) and the combination ring (51) are sequentially mounted around the positioning extension (412) with the two ends of the first spring (54) being received in the two fixing holes (536) of the abutting ring (53). Subsequently, the combination changing device (60) is mounted on the positioning extension (412) with two pins (61) inserted into the two positioning holes (416) of the positioning rod (41).

When the cutouts (524) of the combination wheel assemblies (50) align with the slot (413) of the positioning rod (41), the latch (422) of the latching rod (42) is able to be received in the slot (413) of the positioning extension (412). Then rotation of the combination ring (51) will allow the boss (525) to be received in one of the positioning recesses (512) to secure engagement between the combination ring (51) and the positioning ring (52) and thus the latch (422) is securely received inside the positioning extension (412) and the lock is in a locked status.

To unlock the lock of the conventional lock, the user only needs to align the cutout (524) with the bosses (423) of the latch (422), the latch (422) is able to be retracted from the slot (413).

The conventional lock does have the function to secure safety of an object, however, an unauthorized person may use a technique to unlock the combination lock. The unauthorized person may try to rotate each of the combination ring (51) and then pull down the latching rod (42) trying to allow the bosses (423) to align with and enter the cutout (524) of the positioning ring (52). Eventually, this person may come up with the entire combination, which jeopardizes the safety of the secured object.

Therefore, an objective of the invention is to provide a combination lock to mitigate and/or obviate the aforementioned problems.

### SUMMARY OF THE INVENTION

The main objective of the present invention is to provide a combination lock with which, an unauthorized person is not able to deduce the combination by pulling the latching rod.

In order to accomplish the aforementioned objective, the combination lock of the present invention includes detents defined in a rear side face of the positioning ring such that when an unauthorized person is trying to guess the combination of the lock by feeling the alignment between the bosses of the latching rod and the cutout of the abutting ring, the existence of the detents of the positioning ring confuses the potential thief and thus the object's security is safeguarded.

Other objectives, advantages and novel features of the invention will become more apparent from the following detailed description when taken in conjunction with the accompanying drawings.

### BRIEF DESCRIPTION OF THE DRAWINGS

FIG. 1 is an exploded, perspective view of a combination lock in accordance with the present invention;

FIG. 2 is a perspective view showing the configuration of the positioning ring of the present invention;

FIG. 3 is a schematic cross sectional view showing the assembly of the combination lock of the present invention;

FIG. 4 is a schematic cross sectional view showing that the bosses are received in the detents of the positioning ring when the latching rod is pulled;

FIG. 5 is an exploded perspective view showing a different embodiment of the combination lock of the present invention;

FIGS. 6-9 are perspective views showing different embodiments of the positioning ring of the present invention;

FIG. 10 is an exploded perspective view showing a conventional combination lock; and

FIG. 11 is a schematic cross sectional view showing the assembly of the combination lock shown in FIG. 10.

### DETAILED DESCRIPTION OF THE PREFERRED EMBODIMENT

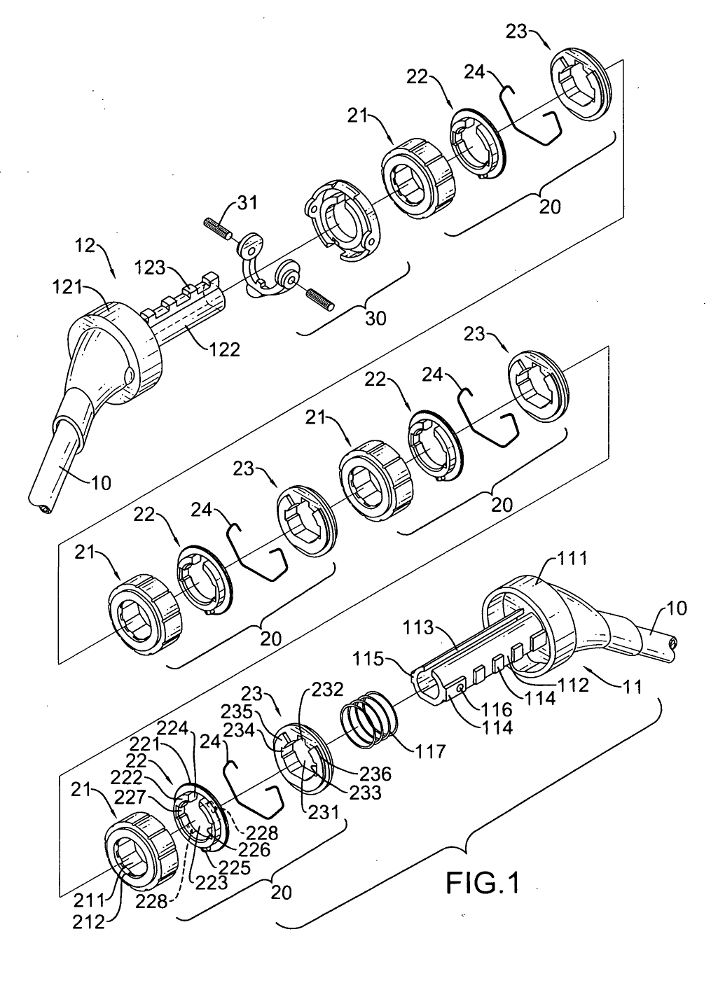

With reference to FIG. 1, a combination lock in accordance with the present invention includes a cable (10) with two ends respectively and integrally provided with a positioning rod (11) and a latching rod (12). Between the positioning rod (11) and the latching rod (12), a combination changing device (30) adjacent to the latching rod (12) and multiple combination wheel assemblies (20) are provided. The positioning rod (11) has an annular covering (111) and a positioning extension (112) centrally extending from an inner face of the annular covering (11 1) and having a flat bottom, a slot (113) defined in a top of the positioning extension (112), first positioning blocks (114) formed on a right side of the positioning extension (112) and second positioning blocks (115) formed on a left side of the positioning extension (112) and the second positioning blocks (115) having a dimension different from that of the first positioning blocks (114). A positioning hole (116) is defined in one of the first positioning blocks (114) close to a free end of the positioning extension (112).

The latching rod (12) has an annular housing (121) and a latch (122) centrally extending from a bottom of the annular housing (121) and having multiple bosses (123) formed on top of the latch (122) to correspond to the slot (113) of the positioning rod (11).

Each combination wheel assembly (20) is composed of a combination ring (21), a positioning ring (22), an abutting ring (23) and a first spring (24). The combination ring (21) is encrypted with numerals (not shown) on sectioned outer surface of the combination ring (21) and has a central hole (211) and multiple positioning recesses (212) defined in an inner face defining the central hole (211) to correspond to the numerals. The positioning ring (22) is configured to have a rim (221) formed on an outer periphery of the positioning ring (22), multiple spatially spaced annular protrusions (222) formed around an inner face of the positioning ring (22) facing the combination ring (21), a centrally defined hole (223) communicating with the central hole (211) of the combination ring (21), a cutout (224) defined through the annular protrusion (222) to correspond to the slot (113) of the positioning rod (11), bosses (225) formed on a bottom periphery of the annular protrusion (222) to correspond to the positioning recess (212) of the combination ring (21), a first receiving recess (226) defined in the inner face defining the hole (223) to correspond to the first positioning block (114) and a second receiving recess (227) defined in the inner face defining the hole (223) to correspond to the second positioning block (115) of the positioning rod (11). The abutting ring (23) has an extension hole (231), a second cutout (232) defined in an inner face defining the extension hole (231), a first mating recess (233) defined in the inner face defining the extension hole (231) to correspond to the first positioning block (114) of the positioning rod (11), a second mating recess (234) defined in the inner face defining the extension hole (231) to correspond to the second positioning block (115) of the positioning rod (11), an annular ridge (235) formed on a side face of the abutting ring (23) facing the positioning ring (22) and two fixing holes (236) oppositely defined in an outer periphery of the annular ridge (235) to correspond to and receive therein two ends of the first spring (24).

When the conventional combination lock is assembled, a second spring (117) is mounted around the positioning extension (112). Then the abutting ring (23), the positioning ring (22) and the combination ring (21) are sequentially mounted around the positioning extension (112) with the two ends of the first spring (24) being respectively received in the two fixing holes (236) of the abutting ring (23). Then the combination changing device (30) is mounted on the positioning extension (112) with two pins (31) respectively inserted into the two positioning holes (116) of the positioning rod (11).

When the cutouts (224) of the combination wheel assemblies (20) align with the slot (113) of the positioning rod (11), the latch (122) of the latching rod (12) is able to be received in the slot (113) of the positioning extension (112). Then rotation of the combination ring (21) will allow the boss (225) to be received in one of the positioning recesses (212) to secure engagement between the combination ring (21) and the positioning ring (22) and thus the latch (122) is securely received inside the positioning extension (112) and the lock is in a locked status.

To unlock the lock of the conventional lock, the user only needs to align the cutout (224) with the bosses (123) of the latch (422), the latch (122) is able to be retracted from the slot (113).

Furthermore, multiple detents (228) are defined in a rear side face of the positioning ring (22) to correspond to the bosses (123) of the latching rod (12). Therefore, when a thief tries to deduce the combination of the lock of the present invention by sequentially rotating the combination ring (51) in a situation where the lock is in a locked status, the bosses (123) will be temporarily received in the detents (228) of the positioning ring (52), which confuses the person's touch and thus the secured object's status is maintained.

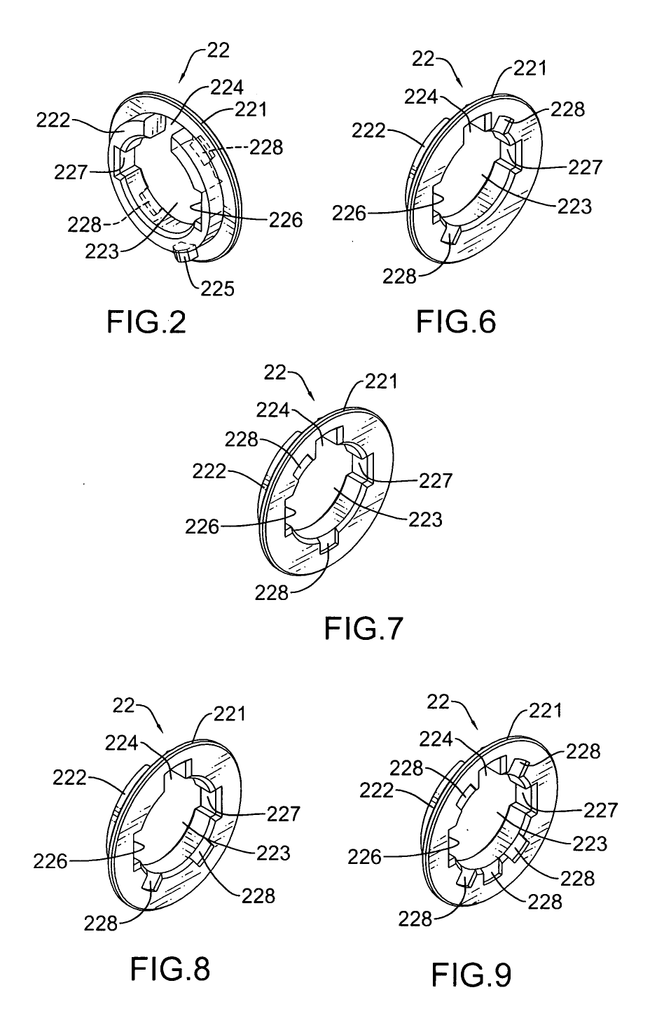

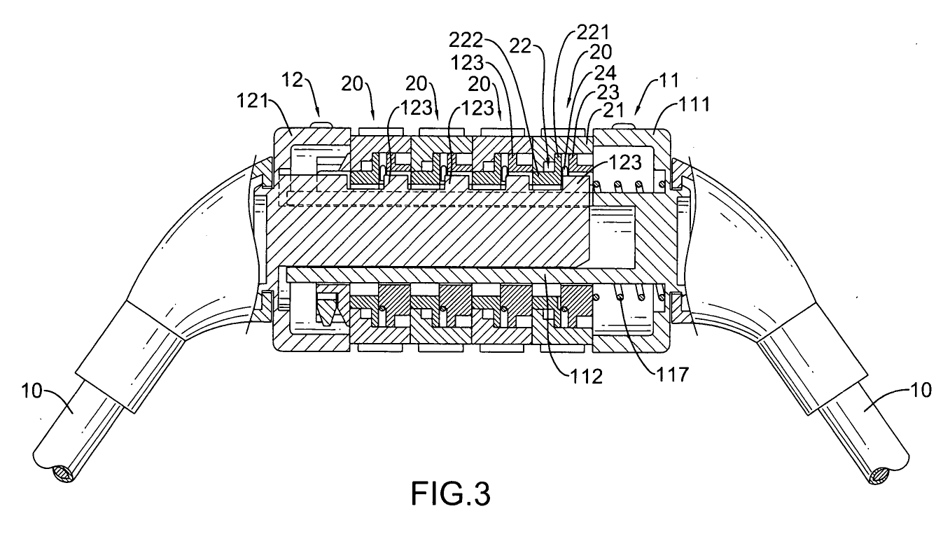

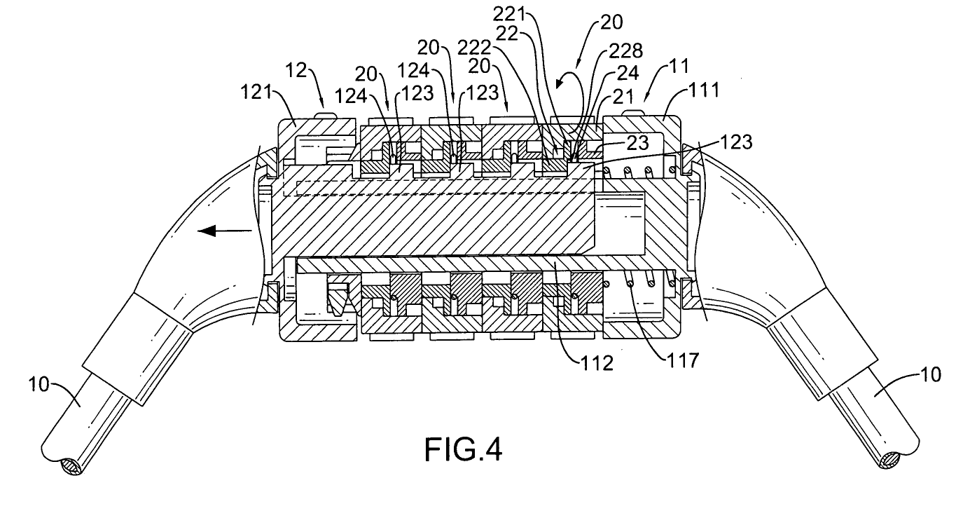

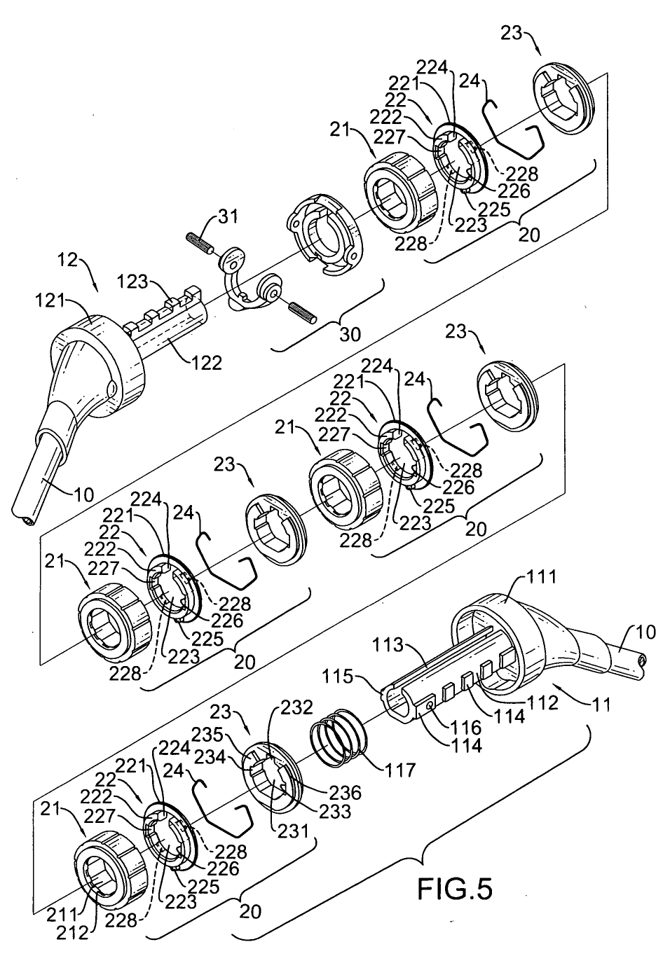

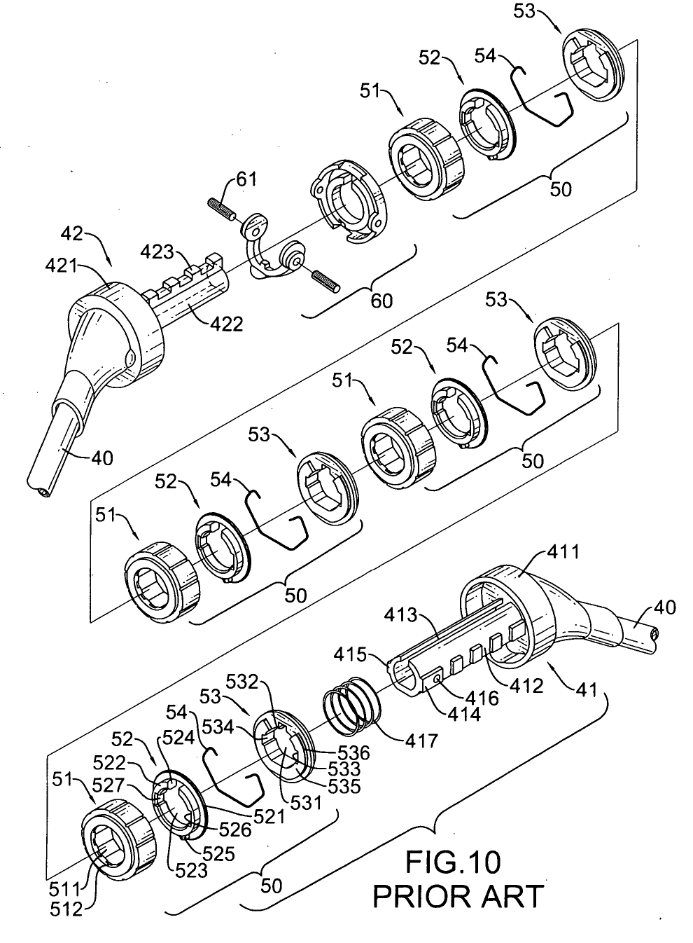

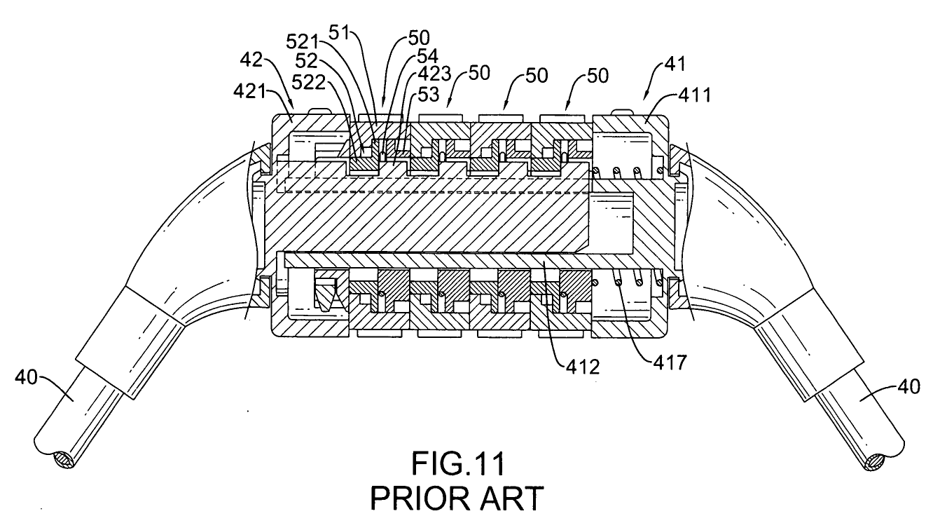

With reference to FIGS. 2, 3, 4 and 5, it is noted that after the combination lock of the present invention is assembled and the positioning rings (21) are rotated, the bosses (123) of the latching rod (12) will be received in the detents (128) of the positioning ring (22) if the combination of the positioning rings (21) is not able to align the bosses (123) with the cutout (124), which confuses the touch of the ill-intended person trying to crack open the combination lock.

With reference to FIGS. 6-9, it is noted that the location of the detents (228) may be diagonally corresponding to each other, off-center formed, sandwiched between the first receiving recess (226) and the second receiving recess (227) or sandwiched between the cutout (224) and the first or the second receiving recess (226,227).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

In the claims:

1. In a combination lock having a positioning extension with a slot defined through a periphery of the position extension, multiple wheel assemblies each with a positioning ring rotatably mounted around the positioning extension and having a cutout selectively aligned with the slot of the positioning extension and a latching rod with multiple linearly formed bosses formed on the latching rod, wherein the improvement comprises:
each of the positioning rings has at least one detent defined in a rear side fact thereof to correspond to and to temporarily receive therein a corresponding one of the bosses of the latching rod while the positioning ring is rotated and the bosses are in mis-alignment with the cutout of the positioning ring.

2. (canceled)

3. (canceled)
